(19) United States
(12) Patent Application Publication
(10) Pub. No.: US 2015/0095262 A1
(43) Pub. Date: Apr. 2, 2015

(54) COMPUTING ENVIRONMENT FOR SOCIAL IMPACT INVESTING

(71) Applicants: Timothy McIntosh, Hockessin, DE (US); Stephen J. Roettger, Wilmington, DE (US); Andrew Briening, Kennett Square, PA (US)

(72) Inventors: Timothy McIntosh, Hockessin, DE (US); Stephen J. Roettger, Wilmington, DE (US); Andrew Briening, Kennett Square, PA (US)

(21) Appl. No.: 14/503,688

(22) Filed: Oct. 1, 2014

Related U.S. Application Data
(60) Provisional application No. 61/885,224, filed on Oct. 1, 2013.

(51) Int. Cl. G06Q 40/06

(52) U.S. Cl. CPC G06Q 40/06
USPC 705/36 R

(57) ABSTRACT

Exemplary embodiments of the present disclosure are directed to a computing environment for social impact investing. The computing environment can be programmed and/or configured to provide a platform for user of the environment to contribute to social impact investment instruments as investors, payors, service providers, and/or creators of social impact investment instruments, such as social impact bonds.

### CROSS-REFERENCE TO RELATED APPLICATION

This application claims priority from U.S. Provisional Application No. 61/885,224, filed Oct. 1, 2013, and is incorporated herein by reference in entirety.

### TECHNICAL FIELD

Exemplary embodiments of the present disclosure generally relates to providing a platform for implementing a computing environment to facilitate social impact investing, and more particularly to a computing environment that enables payors, investors, and service providers to identify and support social impact investment instruments or projects.

### BACKGROUND

The fields of impact investing and social entrepreneurship aim to make the world a better place by harnessing the power of capitalism for social good. One impact investing vehicle that has recently gained momentum is the Social Impact Bond (which may also referred to as a Pay for Success Bond). Social Impact Bonds (SIBs), which are not bonds in the traditional sense, work by aligning interests of investors, payors, and service providers to solve a social problem.

SIBs were designed to shift the risk of a service or program from the government to an investor. There is currently no standard structure for SIBs. In one common implementation of SIBs, investors front money to pay for a service that is designed to fix a social problem (e.g., homelessness, recidivism, education, etc.). Using the money invested by the investors, service providers provide services to fix the social problem with the goal of satisfying predetermined metrics of success. If the predetermined metrics of success are satisfied, payors generally pay the investors an amount of money that equals the investors total investment plus an additional amount of money to compensate the investors for the investment risk (e.g., interest). If the predetermined metrics of success are not satisfied, the payors are not obligated to pay the investors and the investors do not recovery their investments. Often, the government is the payor for SIBs.

One early example of an actual SIB that was implemented was implemented in the United Kingdom with the goal of reducing the recidivism rate by 7.5% at Peterborough prison. In this SIB the payor was the government. For this SIB, if the service provider was effect at reducing the recidivism rate by 7.5%, the government would be obligated to pay back the investors with the savings that were generated as a result of the reduction in recidivism.

Many forward-thinking organizations see SIBs as a way to improve government outcomes and increase efficacies and see the pay for success nature of the bonds as a way to allow governments to try new services, programs and tactics that governments would otherwise never try, with little to no financial risk to the tax payer. However, there is growing concern that governments may not adopt SIBs on a large scale due to the amount the returns that financial investors would expect based on the level of risk associated with such SIBs, which can often be a high. For example, some investors may seek a return of ten times their investment. Such returns are often unobtainable through SIBs.

While the lack of returns may limit the viability of SIBs, there are several other factors may be contributing to the limited use SIBs. For example, use of SIBs may be limited because SIBs are a relatively new type of investment instrument, are often implemented using a closed distribution system, and are often focused on a segment of the market that may have little interest in these type of investment instrument. Furthermore, use of SIBs may be limited because a platform for potential parties of SIBs to collaborate does not exist.

### SUMMARY

Exemplary embodiments of the present disclosure are directed to a computing environment for social impact investing. The computing environment can be programmed and/or configured to provide a platform for users of the environment to contribute to social impact investment instruments as investors, payors, service providers, and/or creators of social impact investment instruments, such as social impact bonds.

Exemplary embodiments, can include, for example, a method, system, and non-transitory computer-readable medium to facilitate using an online portal to pool money to payback an investor in a project, using an online portal to launch a pay for success project, using an online portal to find investors, and payors for a project, automatically calling money on a regular basis to payback an investor in a project, and/or automatically returning money to a payor via an online portal if a project is not successful. In exemplary embodiments, the project is for the social good (or alternatively where the project is a social project), pooled money can be automatically distributed to investors upon successful completion of project milestones, and/or pooled money, minus fees, is automatically distributed to investors upon successful completion of a project.

In exemplary embodiments, a method, system, and computer-readable medium is disclosed for creating one or more graphical user interface to implementing a multi-payor investment environment in a project. A computing environment can be generated in response to an execution code/instructions by a processing device at a server. The computing environment can be implemented to generate multi-payor investment instruments or projects and can be accessible by a plurality of users via a communications network. The computing environment can provide at least one pre-configured graphical user interface for receiving and displaying information to the plurality of users. A request from a user to create a new graphical user interface for a multi-payor investment instrument or project via the at least one pre-configured graphical user interface and the new graphical user interface can be generated by the processing device at the server in response to the request. The new graphical user interface can include information associated with the multi-payor investment instrument or project received in the request. The new graphical user interface can accessible by other users via the computing environment to allow the other users collectively pledge to contribute to the multi-payor investment instrument or project as at least one of a payor, investor, or service provider and/or to view payors, investors, and/or service provides that have pledge to contribute to the multi-payor investment instrument or project.

In exemplary embodiments, a method, system, and non-transitory computer-readable medium are disclosed to facilitate executing code to generate a computing environment for multi-payor investment instruments or projects and executing code to manage payor contributions from the plurality of users with respect to a selected investment instrument or project. The computing environment is accessible by a plurality of users via a communications network and providing at least one graphical user interface for receiving and displaying information to the plurality of users. The payor contributions are payable to an investor for the instrument in response to achieving a desired goal.

In exemplary embodiments, a method, system, and non-transitory computer-readable medium are disclosed to facilitate receiving a user-created social impact investing instrument in a computer-readable format in a computing environment via a communications network. The social impact investing instrument defining a goal to be achieved via the social impact investing instrument, a payor contribution required, an investor contribution required, and a service to be performed that is related to achieving the goal. The method, system, and non-transitory computer-readable medium are disclosed to facilitate executing code to define a composite payor data structure for managing payor information from a plurality of users contributing to the user-created social impact investing instrument. The method, system, and non-transitory computer-readable medium are disclosed to facilitate receiving completion information indicating whether the goal has been achieved and executing code to determine whether to initiate a transfer of funds associated with the payor information to one or more investors in response to the completion information.

Any combination and/or permutation of embodiments is envisioned. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWING

FIG. 1 is a block diagram of an exemplary social impact investment environment in accordance with exemplary embodiments of the present disclosure.

FIG. 2 is a block diagram showing hardware and software components that can be utilized for implementing exemplary embodiment of a social impact investing system.

FIG. 3 is a block diagram of an exemplary client-server environment configured to implement one or more embodiments of the social impact investment environment.

FIG. 4 shows a block diagram illustrating an exemplary implementation of a social impact bond using exemplary embodiments of the social impact investing environment.

FIG. 5 shows a block diagram illustrating an exemplary implementation of a social impact bond using exemplary embodiments of the social impact investing environment.

FIG. 6 is a flowchart illustrating a process for contributing to a social impact investment instrument implemented by exemplary embodiments of the present disclosure.

FIG. 7 is a flowchart illustrating a payor contribution process for contributing to a social impact investment instrument implemented by exemplary embodiments of the present disclosure.

FIG. 8 is a flowchart illustrating an investor contribution process for contributing to a social impact investment instrument implemented by exemplary embodiments of the present disclosure.

FIG. 9 is a flowchart illustrating a service provider contribution process for contributing to a social impact investment instrument implemented by exemplary embodiments of the present disclosure.

FIG. 10 is a flowchart illustrating a process for satisfying or terminating a social impact investment instrument implemented by exemplary embodiments of the present disclosure.

FIG. 11 depicts an exemplary GUI can be rendered on a display upon execution of an exemplary embodiment of the environment to a user to create a social impact investment.

FIG. 12 depicts an exemplary GUI that can be rendered on a display upon execution of an exemplary embodiment of the environment to display project or instrument in response to a search request.

FIG. 13 depicts an exemplary GUI that can be rendered on a display upon execution of an exemplary embodiment of the environment to display user information returned by the environment in response to a search request from a user.

### DETAILED DESCRIPTION

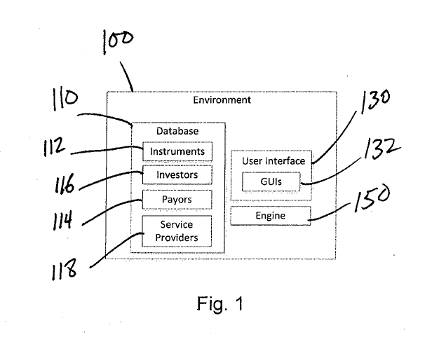

Exemplary embodiments of the present disclosure relate to providing and implementing a social impact investing environment that is accessible by user to permit the user to find and/or contribute to social impact investment instruments as payors, investors, and/or service providers, as discussed in detail below in connection with FIGS. 1-13.

Supporting a social impact bond (SIB) and becoming a payor, or part of a community of payors, is different from making an investment, simply donating money, or being a conditional buyer. Compared to investing, supporting the payor role of a SIB does not provide any monetary gains, and the money is only returned if the bond fails. Compared to a traditional donation, supporting a SIB requires donation only if the cause meets its predetermined metrics for success (although the money could be collected before the SIB starts and is returned if the predetermined metrics for success are not met). Further, the payors' money does not go the service provider or non-profit, it goes to the investor who initially funded the service provider. Finally, this is not like conditional buying (or CPO) because the user is not buying a physical product or service for themselves, and they may not ever be the beneficiary (direct or indirect). SIBs are unique because the payor only pays for success, and the money goes to pay back an investor (although it may go through a number of other parties to get to the investor).

Exemplary embodiments of the present disclosure can create an environment where communities can support social impact investment instruments or projects via an online meeting place, where users can launch or search for social impact investment instruments or projects. Once there, users could launch social impact investment instruments or projects by selecting the predetermined metrics for success, finding people and organizations to be the payors, service providers, and investors for the social impact investment instrument or project. Further, users could support social impact investment instruments or projects and become payors by pledging money, in any amount, to the instruments or projects. This money can be called before the starts of or after the instrument or project is successfully completed. It can be called in full, or in different increments.

Exemplary embodiments of the present disclosure overcome several problems currently limiting the wide scale efficient and effective use of SIBs. As one example, exemplary embodiments of the present disclosure can advantageously provide an open, transparent electronic marketplace or environment for SIBs that can be utilized by traditional and/or non-traditional stakeholders invest in and/or pay for SIBs, which differs from making an traditional investment, simply donating money, and/or being a conditional buyer. In exemplary embodiments, the electronic marketplace or environment can advantageously allow many different stakeholders, other than the traditional governments and foundations, to become involved in SIBs, such as individual citizens who wish to support and/or create SIBs to address social problems. Users of the electronic marketplace or environment can be an investor, a service provider, and/or a payor.

Exemplary embodiments of the electronic marketplace or environment can advantageously facilitate a composite payor structure in which different entities (e.g., the government, foundations, corporations, and individuals) each contribute a portion of the amount required to fund an SIB and/or a composite investor structure in which different entities (e.g., corporations, foundations, associations, individuals) each invest a portion of the amount required to achieve performance of a service directed to addressing a social problem. The contributions from each entity can be pooled to pay the service provider(s), wherein service provider information can be maintained in a composited service provider structure.

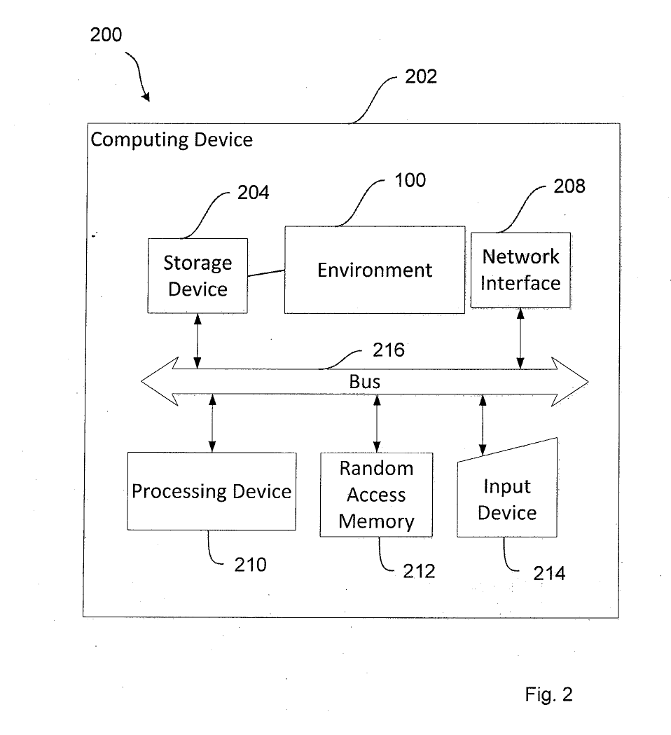

FIG. 1 is a block diagram of an exemplary social impact investment environment 100 in accordance with exemplary embodiments of the present disclosure. Exemplary embodiments of the environment 100 can be implemented using hardware, software, and/or a combination thereof. For example, in one exemplary embodiment, one or more computing devices can be programmed and/or configured to implement exemplary embodiments of the environment 100. An exemplary embodiment of a computing device configured to implement embodiments of the environment 100, or portions thereof, is shown, for example, in FIG. 2. The environment 100 can include a database 110, a user interface 130, and a social impact investing engine 150 and can be programmed and/or configured to allow users to search for, specify (e.g., create), contribute to, and/or monitor social impact investment instruments. In some embodiments, the environment can be implemented as a web-based portal that can be accessed by users via a web browser. In some embodiments, the environment 100 can be incorporated into an entity's website such that the entity operates the environment to allow the entity to post their social impact investment instruments and/or other entities' social impact investment instruments and to allow contributions to the instruments through their website. For example, an entity can have a “support” tab on their website that lists instruments for which the entity is currently trying to find investors, payors, and/or service providers. By accessing the environment via the entity's website, users can invest, support, or participate in the instruments.

The database 110 can include information that can be retrieved and/or accessed by the users of the environment 100. For example, the database 110 can include information about social impact investment instruments 112, information about potential payors 114, information about potential investors 116, and/or information about potential service providers 118. In exemplary embodiments, the database 130 can be programmed and/or configured to associate the information about the social impact investment instruments 112, potential payors 114, potential investors 116, and/or potential service providers 118. In some embodiments, the associations maintained by the database 110 can be used by the environment 100 to identify social impact investment instruments 112, potential investors 114, potential payors 116, and/or potential service providers 118 in response to a search request from the user. For example, a user can search for a social impact investment instrument for which the user can become a payor, investor, and/or service provider. Users can qualify as payors, investors, service providers, and/or a combination thereof, based on profile information for the users. When the environment 100 accesses the information in the database 110, the environment 100 can return a list of available social impact investment instruments and can include in the list the identity of investors, payors, and/or service providers that have expressed interest in the instruments and/or have committed to the instruments and/or can suggest investors, payors, and/or service providers having profiles that may be a good fit for the instruments.

The information about the social impact investing instruments 112 can include, for example, a name of the instruments, a description of the instruments, financial information for the instruments, entities that have committed to the instrument, and the like. The description of a social impact investing instrument can describe the social benefit sought to achieved using the funds generated by the instrument, a type of service that will be used to achieve the social benefit, a time-period for achieving the social benefit, a predetermined metric used to determine if the service to be performed is successful upon completion of the project or at the expiration of the time period, a creator of the instrument, and/or any other suitable information that can be used to describe the instrument. The financial information for a social impact investing instrument can include an amount of funds to be invested before performance of the service associated with the instrument begins, a return on the investment should the outcome of the service satisfy the predetermined metrics for success, an amount of funds to be contributed to the instrument by the payor(s) of the instrument, a schedule of disbursements to the service providers for their services, and/or any other financial information that can be used by users of the environment 100 to determine whether to contribute to the instrument as an investor, payor, and/or service provider.

The information about the potential investors 114 can include, for example, one or more users of the environment 100 that have setup an account with the environment 100 and have entered profile information into the environment 100. The profile information can include a name of the user (e.g., an individual, an organization, a foundation), an address of the user, a phone number of the user, an e-mail address of the user, and/or any other contact information for the user. In exemplary embodiments, the profile information for a potential investor can include qualifying information to establish the user as a potential investor in the environment. For example, the profile information can include, an estimated net worth, prior investments by the user in social impact investing instruments, and/or any other information that may be useful and/or required to establish that the user can be a potential investor in the environment 100.

The information about the potential payors 116 can include, for example, one or more users of the environment 100 that have setup an account with the environment 100 and have entered profile information into the environment 100. The profile information can include a name of the user (e.g., an individual, an organization, a foundation), an address of the user, a phone number of the user, an e-mail address of the user, and/or any other contact information for the user. In exemplary embodiments, the profile information for a potential investor can include qualifying information to establish the user as a potential payor in the environment 100. For example, the profile information can include, an estimated net worth, social impact investing instruments for which the user was previously a payor, and/or any other information that may be useful and/or required to establish that the user can be a potential payor in the environment 100.

The information about the potential service providers 118 can include, for example, one or more users of the environment 100 that have setup an account with the environment 100 and have entered profile information into the environment 100. The profile information can include a name of the user (e.g., an individual, an organization, a foundation), an address of the user, a phone number of the user, an e-mail address of the user, and/or any other contact information for the user. In exemplary embodiments, the profile information for a potential service provider can include qualifying information to establish the user as a potential service provider in the environment 100. For example, the profile information can include, reviews/recommendations from other users of the environment 100, social impact investing instruments for which the user was previously a service provider, a success rate of the service provider for previous service rendered for a social impact investing instrument, and/or any other information that may be useful and/or required to establish that the user can be a potential service provider in the environment 100.

In exemplary embodiments, the user interface 130 can be programmed and/or include configured to provide one or more graphical user interfaces (GUIs) 132 through which users can interact with the environment 100 to create new graphical user interfaces for new social impact investment instruments or projects, search for existing social impact investment instruments or projects, contribute to existing social impact investment instruments or projects, identify potential investors, payors, and/or services provides for the new and/or existing social impact investing instruments or projects. In some embodiments, the user interface 110 can be associated with one or more web pages that can be accessed via a client-side application. The GUIs 132 displayed to the users can include data output areas to display information to the users and/or data entry areas to receive information from the users. As one example, the GUIs 132 can included data entry areas that allow the users to create a new graphical user interface for a new social impact investment instrument or project. As one example, one or more of the GUIs 132 can display the information about social impact investment instruments that the user can contribute to as an investor, a payor, and/or a service provider. As another example, the GUIs 132 can included data entry areas that allow the users to search for social impact investment instruments, potential investors, potential payors, and/or potential service providers; specify or create social impact investment instruments; and/or contribute to social impact investment instruments (e.g., as a payor, an investor, and/or service provider). Some examples of data entry fields include, but are not limited to text boxes, check boxes, buttons, dropdown menus, and/or any other suitable data entry fields.

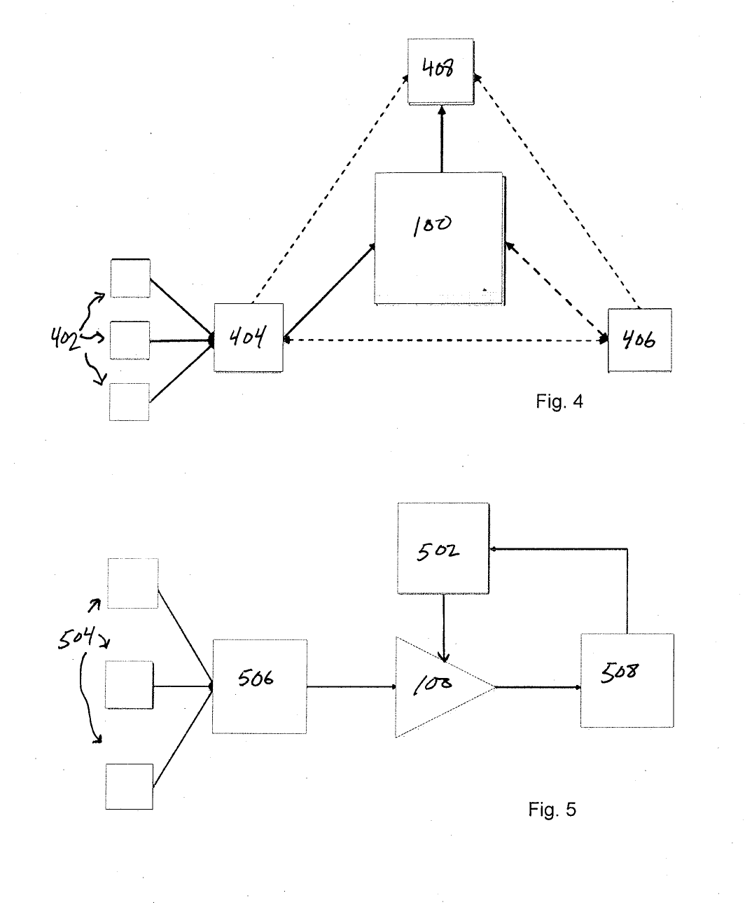

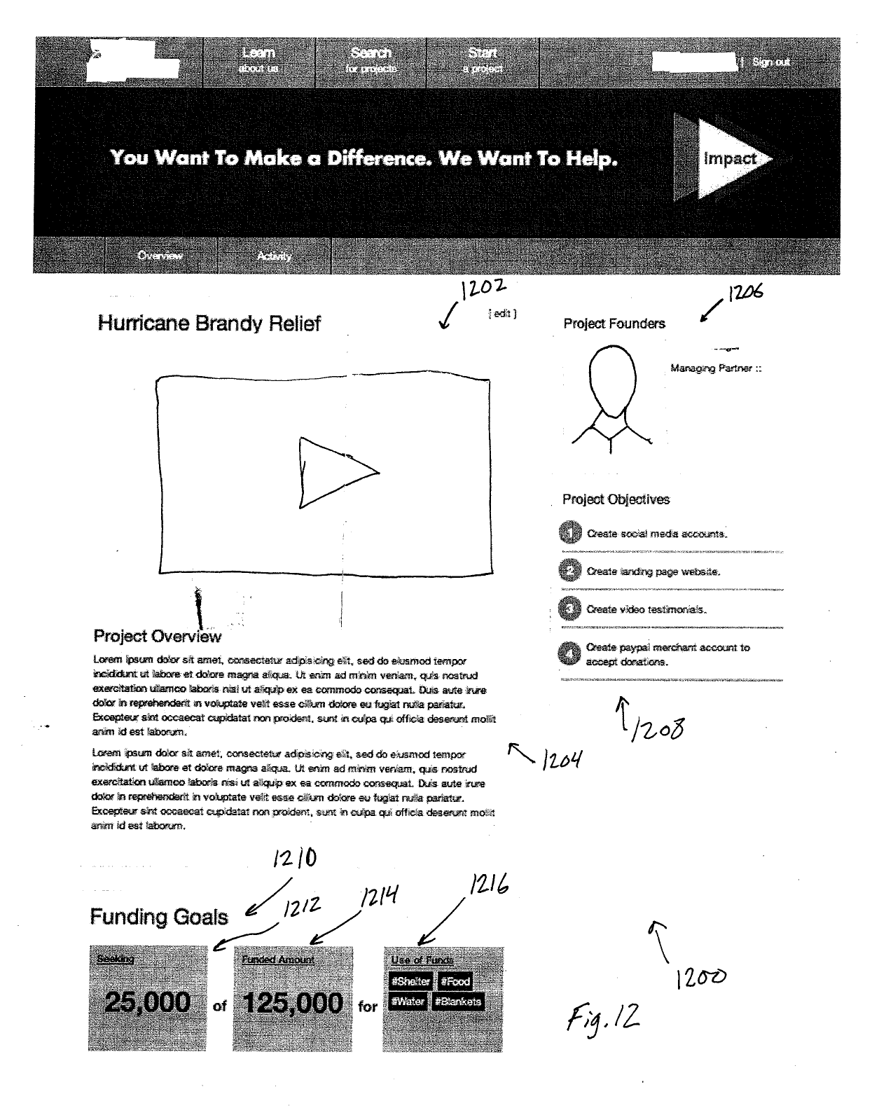

The social impact investing engine 150 can be programmed and/or configured to implement one or more processes to provide and/or implement the environment 100. For example, exemplary embodiments of the engine 150 can be configured to implement the processes described with respect to FIGS. 4-10 and to generate the GUIs depicted in FIGS. 11-13. In exemplary embodiments, the engine 150 can be programmed and/or configured to process inputs received by the user of the environment 100 and to output information/data in response to the inputs. For example, the engine can be programmed to receive requests from the user for information stored in the database 100 and the engine 150 can create one or more queries to access the information/data, can retrieve the information/data and can instruct the user interface 130 to display the information/data to the user(s) in one or more of the GUIs 132.

The engine 150 can also maintain and manage contributions by the users to the social impact instruments. As one example, in some embodiments, the engine 150 can maintain a composite payor data structure including information/data associated with payors of the instrument, can maintain a composite investor data structure to maintain information/data associated with the investors of the instrument, and/or can maintain a composite service provider data structure including information/data associated with service providers of the instrument. As another example, the engine 150 can be programmed and/or configured to determine when contributions to the payor, investor, and service provider portions have be satisfied and/or fulfilled and can update information in the database 110 to associate such satisfaction and/or fulfillment with the instrument.

In some embodiments, the engine 150 can be programmed and/or configured to raise and collect payor contributions after successful completion of SIB such that exemplary embodiments of the environment can be programmed and/or configured to receive pledges of money to an SIB, and these pledges may only called once there is successful completion of predetermined metrics of success (i.e. reduce the recidivism rate by 7.5%). If the metrics are not met, the pledged money is never called. For example, a community wants to reduce the 12-month recidivism rate at certain prison. Doing so is important to the government and the citizens. Combined the government and citizens pledge $5,000,000 to a social impact bond designed to reduce the 12-month recidivism rate at a prison for 5 years. If at the end of the 5 years the bond is successful (i.e. the recidivism rate is reduced by 7.5% at the end of 5 years), the government and the citizens pay their pledged money to the investor, who makes profit on the bond. If the bond is unsuccessful the investors lose their money, and the pledged money is never called.

In some embodiments, the engine 150 can be programmed and/or configured to raise and collect payor contributions before successful completion of an SIB such that exemplary embodiments of the environment can be programmed and/or configured to receive pledges of money to an SIB, and these pledges can be called in full or partial, before the successful completion of predetermined metrics of success (i.e. reduce the recidivism rate by 7.5%). If the metrics are not met, the called money is returned. As one example, a community wants to reduce the 12-month recidivism rate at a certain prison. Doing so is important to the government and the citizens. Combined, the government and citizens pledge $5,000,000 to a social impact bond designed to reduce the 12-month recidivism rate at a prison for 5 years. The bond sponsor selects to call half of the pledged money before the bond starts and the other half upon a successful completion (i.e. the recidivism rate is reduce by 7.5% at the end of 5 years). If the bond is unsuccessful the investors lose their money and the pledged money that was called would be returned to the government and citizens. As another example, pledges of money can be called in increments or intervals before or after the successful completion of predetermined metrics of success (i.e. reduce the recidivism rate by 7.5%). If the metrics are not met, the called money is returned (when applicable).

To continue with the previous example in which a community wants to reduce the 12-month recidivism rate at certain prison, the government and citizens may combine to pledge $5,000,000 to a social impact bond. The bond sponsor selects to call the pledged money monthly for the first 2.5 years. Each month, 1/30 (2.5×12=30) of the pledger's pro-rata amount of the pledge is called by exemplary embodiments of the engine 150, until all of the pledged money is collected. So if a citizen pledged $500 to the bond, each month they would have $16.67 called ($16.67×30=$500) plus fees where and when applicable. Another variation on this might be that the payor simply chooses to pay or pre-pay the commitment on a monthly basis. If at the end of the 5 years the bond is successful (i.e. the recidivism rate is reduce by 7.5% at the end of 5 years), the pledge and called money is given to the investor, who makes profit on the bond. If the bond is unsuccessful the investors lose their money, and the called money is returned to the citizens and government.

In the case that the bond is unsuccessfully raised before it starts (e.g., fails to raise its target amount), exemplary embodiments of the engine 150 can be programmed and/or configured to release the payors from their pledges. For example, if in our previous recidivism example, at the end of a year, $5,000,000 was not raised, the government and citizens would be released of their pledges and the bond would be declared unsuccessfully raised by the engine 150.

In exemplary embodiments, the engine 150 can be programmed and/or configured to encourage or incentivize contribution from payors, investors, and/or service providers by offering incentives or rewards. For example, in some embodiments, a contributor to an SIB may get a t-shirt for a $50 pledge.

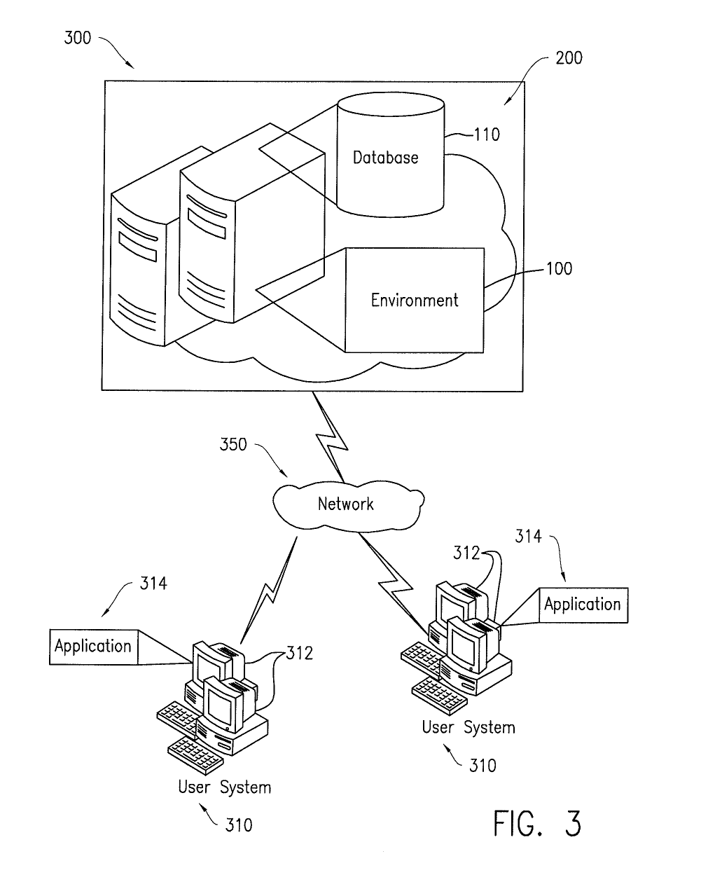

FIG. 2 is a diagram showing hardware and software components that can be utilized for implementing exemplary embodiment of a social impact investing system 200. The system 200 can include a computing device 202 having a storage device 204, a network interface 208, a communications bus 216, a processing device 210 (e.g., a microprocessor), and random access memory (RAM) 212. In some embodiments, one or more input devices 214, e.g., a keyboard, a mouse, and the like, can be in communication with the computing device 202. In some embodiments, the computing device 202 can also interface with a display device. The storage device 204 can include any suitable, non-transitory computer-readable storage medium, e.g., a disk, non-volatile memory, read-only memory (ROM), erasable programmable ROM (EPROM), electrically-erasable programmable ROM (EEPROM), flash memory, and the like. The computing device 202 can be, e.g., a networked computer system, a personal computer, a smart phone, a tablet, and the like. In some embodiments, the computing device 202 can be implemented as a server in a client-server environment. An exemplary client-server environment is shown in FIG. 3.

In exemplary embodiments, exemplary embodiments of the environment 100 can be embodied as computer-readable/executable program code stored on the non-transitory computer-readable storage device 204 and can be executed by the processing device 210 using any suitable, high or low level computing language and/or platform, such as, e.g., Java, C, C++, C#, Python, Ruby, and the like. Execution of the computer-readable code by the processing device 210 can cause the environment 100 to implement one or more processes to manage the social impact investment instruments and/or an interaction between the users and the environment 100.

The network interface 208 can include, e.g., an Ethernet network interface device, a wireless network interface device, any other suitable device which permits the computing device 202 to communicate via the network, and the like. The processing device 210 can include any suitable single- or multiple-core microprocessor of any suitable architecture that is capable of implementing and/or executing the environment 100.

The RAM 212 can include any suitable random access memory typical of most modern computers, such as, e.g., dynamic RAM (DRAM), static RAM (SRAM), and the like. The processing device 210 can retrieve and store data/information to and from the storage device 204 and/or the RAM 212. For example, the database 130 including information about social impact investment instruments 112, potential investors 114, potential payors 116, and/or service providers 118 (FIG. 1), may be stored on the the storage device 204 and/or a RAM 412. In some embodiments, the data/information and/or executable code for implementing the environment 100 can be retrieved from the storage device 204 and copied to RAM 212 during and/or upon implementation of the environment. Once the data/information has been used, updated, modified, replace, and the like, the data/information may be copied from RAM 212 to the storage device 204.

FIG. 3 is a block diagram of an exemplary client-server environment 300 configured to implement one or more embodiments of the environment 100. The environment 300 includes an exemplary embodiment of the social impact investing system 200 operatively coupled to user systems 310, via a communication network 350, which can be any network over which data/information can be transmitted between devices communicatively coupled to the network 350. For example, the communication network 350 can be the Internet, an Intranet, virtual private network (VPN), wide area network (WAN), local area network (LAN), and the like. The system 200 can include the environment 100 executing the user interface 130 and engine 150 and can be configured to retrieve and store data/information in database 110, as described herein.

The user systems 310 can include one or more electronic devices 312 configured to communicate with the system 200 via the network 350. In exemplary embodiments, the electronic devices 312 can include an application 314 programmed and/or configured to facilitate access the environment 100 to search for and/or view information about social impact investment instruments, potential investors, potential payors, and/or potential service providers; specify or create a social impact investment instrument; and/or commit to social impact investment instruments (e.g., become an investor or payor for a social impact investment instrument). In some embodiments, the application 314 implemented by one or more of the electronic devices 312 can be a web-browser capable of navigating to one or more web pages hosting graphical user interfaces (GUIs) generated by the environment 100 that allow the operators of the electronic devices 312 to interact with the environment 100 via the system 200. In some embodiments, the application 314 implemented by one or more of the electronic devices 312 can be an application specific to the environment 100 to permit access to the environment 100 via the system 200. In some embodiments, the application specific to the environment 100 can be a mobile application installed and executed by the electronic devices 312.

FIG. 4 shows a block diagram illustrating an exemplary implementation of a social impact bond using exemplary embodiments of the environment 100. Users 402 can pool their commitments or pledges to form a composite payor structure 404 for a social impact investing instrument available in the environment 100. Investors 406 can send money to service providers 408 to initial a project associated with the social impact bond. The money can be sent to the service provider through environment 100 and/or external to the environment 100. Upon successful completion of the social impact bond, money is paid to the investors 406 via the composite payor structure 404 and according to the terms of the social impact bond. The money can be paid to the investor either using the environment 100 and/or can be paid to the investors 406 external to the environment 100. If the social impact bond is unsuccessful, the money contributed by the users 402 is not paid to the investors 406 and if the social impact bond is called, the money is returned to the user 402 via the composite payor structure.

In FIG. 4, the users 402 can be different stakeholders, such as government municipalities, small businesses, foundations, universities, individuals, and/or any other suitable users. Each user can support the bond with different amounts of money, and if the bond organizers agree, they can pledge it over different periods of time. The environment 100 can maintain information about the contributions from each of the users in the composite payor structure so that if the social impact bond is unsuccessful, the environment 100 programmatically determine an amount if money due to each user.

FIG. 5 shows a block diagram illustrating an exemplary implementation of a social impact bond using exemplary embodiments of the environment 100. As shown in FIG. 5, the environment 100 can be programmed to receive information from a service provider 502 (or an auditor or designated reviewer of the service provider) indicate whether the service performed by the service provider 502 was successful at achieving the predetermined metrics of success associated with the social impact bond. If the social impact is successful, money can be collected from users 504 and combined into a composite payor structure 506 by the environment 100, which can be utilized to pay the investor(s) 508 the money held by the composite payor structure 506.

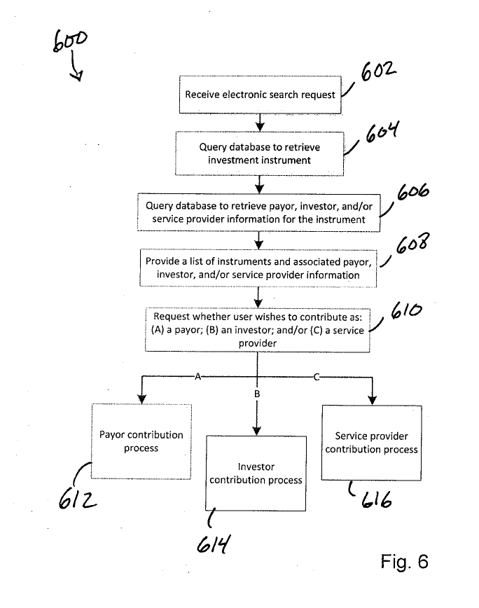

FIG. 6 is a flowchart illustrating a process 600 for contributing to a social impact investment instrument implemented by exemplary embodiments of the present disclosure. At step 602, an embodiment of the environment 100 can receive an electronic search request from a user via one or more GUIs provided by the environment 100. For example, a user can interact with the user's electronic device to interface with an embodiment of the social impact investing system 200 via a communications network (e.g., communications network 350). The user's electronic device can transmit the electronic search request through the communications network to the system 200 and the system 200 can execute the engine 150 of environment 100 to process the request. At step 604, the system 200 can execute the engine 150 of the environment 100 to query the database 110 to retrieve information for social impact investment instruments maintained by the environment 100, and at step 606, the system 200 can execute the engine 150 of the environment 100 can query the database 110 to retrieve payor, investor, and/or service provider information associated with the information for the social impact investment instruments retrieved by the environment 100.

At step 608, the system 200 can execute the user interface 130 and the engine 150 to provide a list of the social impact investment instruments and their associated payor, investor, and/or service provider information for display on the user's electronic device via one or more GUIs of the user interface 130. At step 610, the system 200 can execute the user interface 130 and engine 150 to request an input from the user to select whether the user wishes to contribute to the social impact investing instrument as a payor, investor, and/or service provider. If the user selects to contribute as a payor, the process 600 proceeds to step 612 to implement a payor contribution process. If the user selects to contribute as an investor, the process 600 proceeds to step 614 to implement an investor contribution process. If the user selects to contribute as a service provider, the process 600 proceeds to step 616 to implement a service provider contribution process.

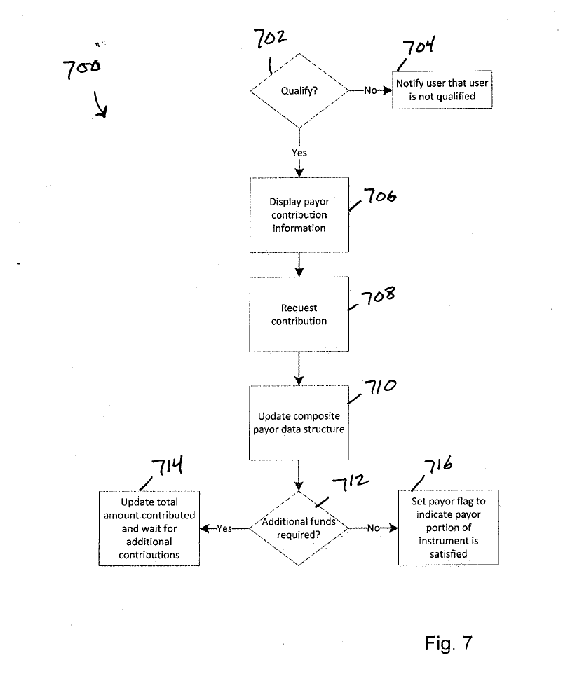

FIG. 7 is a flowchart illustrating a payor contribution process 700 for contributing to a social impact investment instrument implemented by exemplary embodiments of the present disclosure. In response to a selection by the user that the user wishes to contribute as a payor, the environment 100 can be executed by the system 200 at step 702 to determine whether the user qualifies as a payor for the social impact investment instrument. If not, the environment can notify the user that the user does not qualify as a payor for the instrument at step 704. If the user qualifies as a payor, the environment can be executed by the system at step 706 to display a total amount of money required by payor(s) to fund the social impact investing instrument, an amount of money that has already been contributed, and/or an amount of money that still needs to be contributed. At step 708, the system 200 can execute the environment 100 to request an amount to be contributed and a payment method for the contribution (e.g., credit card, debit card, check, money transfer, cash). At step 710, the environment can be executed by the system 200 to process the payment information provided the user and can update a composite payor data structure to include information about the user and the user's contribution. For example, in some embodiments, the composite payor data structure can be a data/information stored in a computer-readable format that can be represent as a table, spreadsheet, graph. In some embodiments, the composite payor data structure can be an eXtensible Mark-up Language (XML) file maintained by the environment 100.

At step 712, the system 200 can execute the environment 100 to determine whether additional funds are required to fulfill the payor obligation for the social impact investment instrument. If so, the environment can be executed to update the amount contributed to the social impact investing instrument and can wait for additional payor funds to be contributed at step 714. If not, the environment can be executed to update the amount of funds contributed and can close the payor portion of the instrument at step 716. Once the payor portion of the instrument is closed, the environment can set a payor closed flag at step 718 such that the next time the instrument information is viewed by a user, the environment can indicate that the payor portion of the instrument has been satisfied.

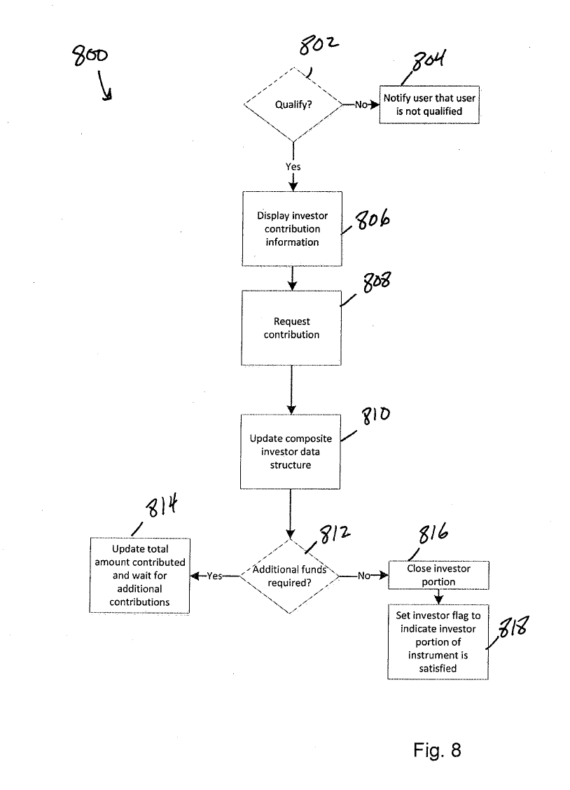

FIG. 8 is a flowchart illustrating an investor contribution process 800 for contributing to a social impact investment instrument implemented by exemplary embodiments of the present disclosure. In response to a selection by the user that the user wishes to contribute as an investor, the environment 100 can be executed by the system 200 at step 802 to determine whether the user qualifies as an investor for the social impact investment instrument. If not, the environment can notify the user that the user does not qualify as an investor for the instrument ate step 804. If the user qualifies as an investor, the environment can be executed by the system at step 806 to display a total amount of money required by investor(s) to fund the social impact investing instrument, an amount of money that has already been contributed, and/or an amount of money that still needs to be contributed. At step 808, the system 200 can execute the environment 100 to request an amount to be contributed and a payment method for the contribution (e.g., credit card, debit card, check, money transfer, cash). At step 810, the environment can be executed by the system 200 to process the payment information provided the user and can update a composite investor data structure to include information about the user and the user's contribution. For example, in some embodiments, the composite investor data structure can be a data/information stored in a computer-readable format that can be represent as a table, spreadsheet, graph. In some embodiments, the composite investor data structure can be an eXtensible Mark-up Language (XML) file maintained by the environment 100.

At step 812, the system 200 can execute the environment 100 to determine whether additional funds are required to fulfill the investor obligation for the social impact investment instrument. If so, the environment can be executed to update the amount contributed to the social impact investing instrument and can wait for additional investor funds to be contributed at step 814. If not, the environment can be executed to update the amount of funds contributed and can close the investor portion of the instrument at step 816. Once the investor portion of the instrument is closed, the environment can set a investor closed flag at step 818 such that the next time the instrument information is viewed by a user, the environment can indicate that the investor portion of the instrument has been satisfied.

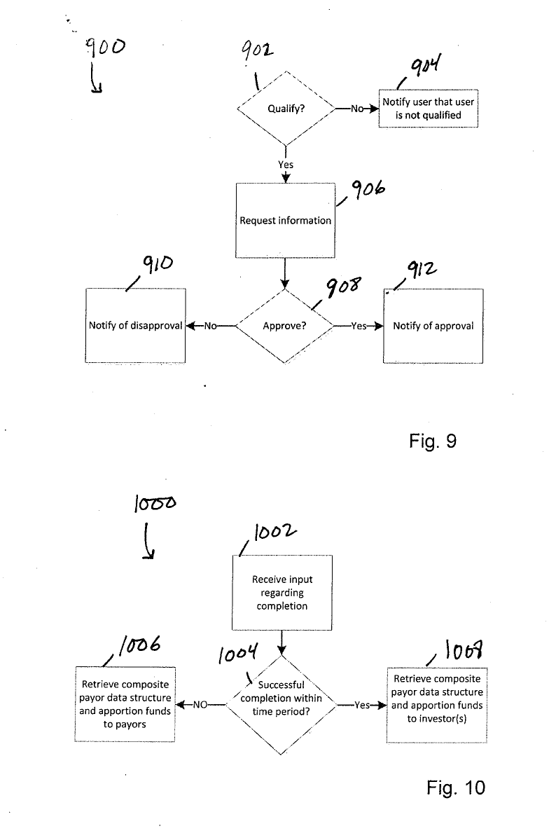

FIG. 9 is a flowchart illustrating a service provider contribution process 900 for contributing to a social impact investment instrument implemented by exemplary embodiments of the present disclosure. In response to a selection by the user that the user wishes to contribute as a service provider, the environment 100 can be executed by the system 200 at step 902 to determine whether the user qualifies as a service provider for the social impact investment instrument. If not, the environment can notify the user that the user does not qualify as service for the instrument at step 904. If the user qualifies as a service provider, the environment can be executed by the system at step 906 to request information from the service provider for consideration by the creator(s), investor(s), and/or payor(s) of the social impact investment instrument and/or for consideration and approval. At step 908, the creator(s), payor(s), and/or investor(s) can vote via the environment to approve or disapprove the potential service provider. If the service provider does not receive approval, the service provider can be notified of the disapproval at step 910. If the service provider receives approval, the service provider can be notified of the approval at step 912. In exemplary embodiments, the environment 100 can utilize a service provider data structure to maintain information for services providers contributing to an instrument. While FIG. 9 is illustrative of a service provider contribution process, those skilled in the art will recognize that exemplary embodiments can may or may not have a service provider contribution process. For example, in some embodiments, the creator of the instrument can specify the service provider information for the instrument.

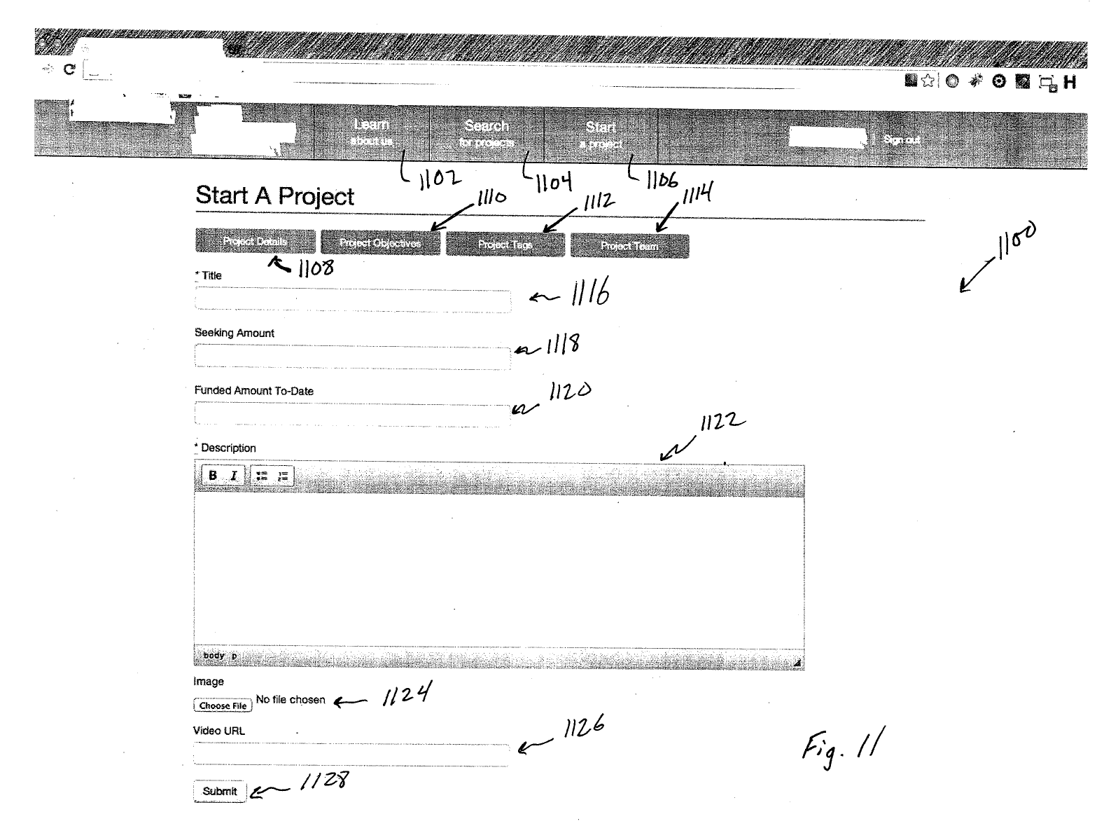

FIG. 10 is a flowchart illustrating a process for satisfying or terminating a social impact investment instrument implemented by exemplary embodiments of the present disclosure. After the payor, investor, and service provider portions of the instrument are accounted for, the environment can be executed at step 1002 to receive inputs from the creator and/or service provider, and at step 1004 to determine whether performance of the service associated with the instrument was successful (e.g., whether predetermined success metrics specified for the instrument in the environment were satisfied) and/or whether a time period for completion of the service associated with the instrument has expired. If the time period expires before successful completion or the service was not successful, the environment can be executed by the system 200 at step 1006 to retrieve the composite payor data structure and to apportion the payor funds amongst the payors based on each payor's contribution. If the service was successful before the time period expires, the environment can be executed by the system 200 at step 1008 to retrieve the composite investor data structure and to apportion the payor funds amongst the investors based on each investor's contribution. If the time period has not expired and the service has not been completed, no action is taken by the environment.

FIG. 11 depicts an exemplary GUI 1100 that can be rendered on a display upon execution of an exemplary embodiment of the environment 100 to allow a user to create a new graphical user interface for a social impact investment in response to information input by the user as a request in a computer-readable format via the GUI 1100. As shown in FIG. 11, the GUI 1100 can include selectable tabs 1102, 1104, and 1106. The selectable tab 1102 can be selected by a user to navigate to an information GUI that describes the environment and/or the entity providing the environment. The selectable tab 1104 can be selected by the user to navigate to a GUI that allows user to search for instruments or projects, payors, investors, and/or service providers. The selectable tab 1106 can be selected by a user to navigate to the GUI 1100 to allow the user to create a social impact investment instrument or project.

The GUI 1100 can include a project details tab 1108, a project objectives tab 1110, a project tags tab 1112, and a project team tab 1114. The user can select the tabs 1108, 1110, 1112, and 1114 to navigate to GUI to allow the user to specify portions of the instrument or project to be created. In the present embodiment, the user has selected the project details tab 1108 and the GUI can include data entry fields 1116, 1118, 1120, 1122, 1124, and 1126. The data entry field 1116 requests that the user enter a title to be associated with the project or instrument. The data entry field 1118 requests the user enter amount of fund being sought for the project or instrument. The data entry field 1120 requests the user enter an amount of funds that the project or instrument has already received. The data entry field 1122 requests the user to enter a description about the project or investment, The data entry filed 1124 allows the user to upload an image to be associated with the project or instrument. The data entry field 1126 allows a user to specify a video to be associated with the project or instrument. After the user has entered the requested information, the user can select a submit button 1128 to submit the project or instrument to the environment for creation.

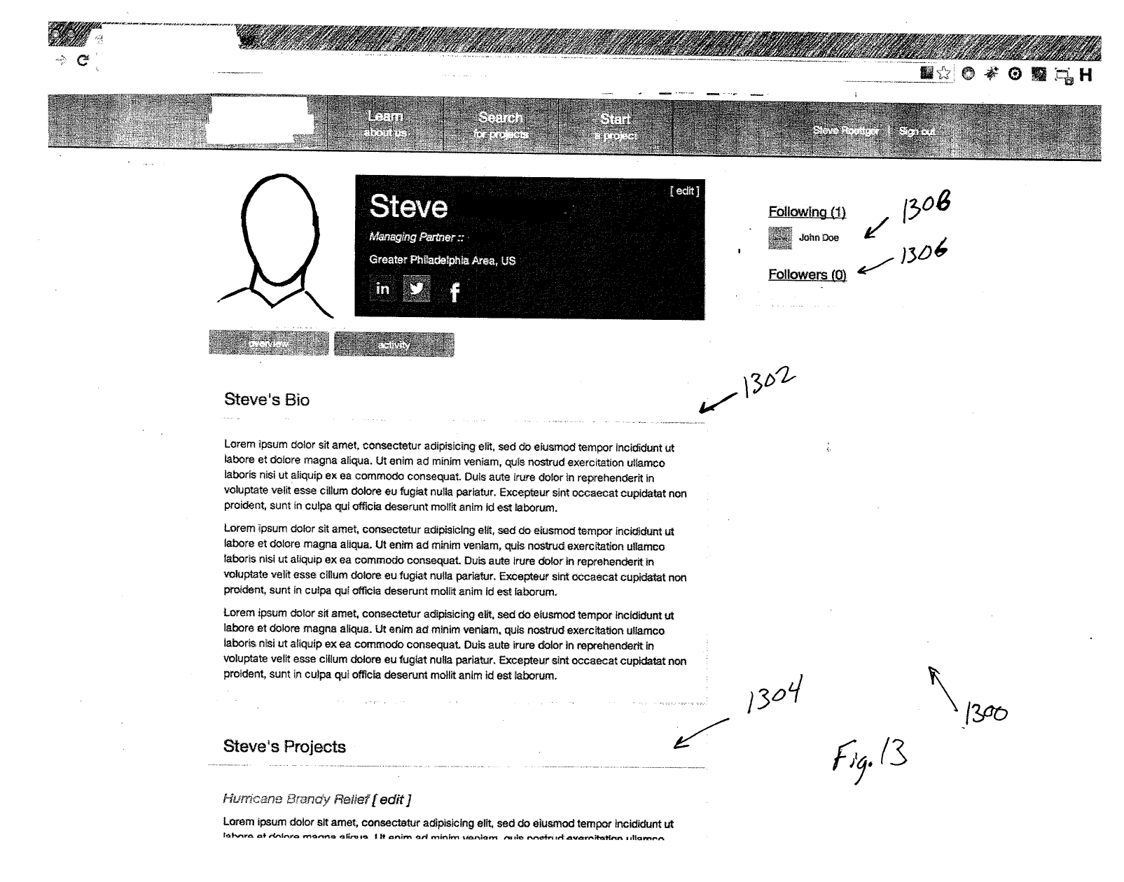

FIG. 12 depicts an exemplary GUI 1200 that can be created in response to the information input as a request in the GUI 1100 (FIG. 11) and can be rendered on a display upon execution of an exemplary embodiment of the environment 100 to display project or instrument in response to a search request from other users. The GUI 1200 can include a video 1202 associated with the project or instrument and can include a project overview 1204 of the project or instrument. In exemplary embodiments, the GUI 1200 can include information 1206 about the creators, investors, payors, and/or service providers that are interested in contributing, have contributed or have pledged to contribute to the project or instrument; can include a list of objectives 1208 for the project or instrument; and can allow users to contribute or pledge to contribute to the project or instrument. As shown in FIG. 12, the GUI 1200 can display funding goals 1210 for the project or instrument, which can include, for example, an amount of funds being sought 1212, an amount of funds already contributed 1214, and a proposed use of the funds 1216.

FIG. 13 depicts an exemplary GUI 1300 that can be rendered on a display upon execution of an exemplary embodiment of the environment 100 to display user information returned by the environment 100 in response to a search request from a user. As shown in FIG. 13, the user information can include a biography 1302 about the user and the user's current projects 1304. The current projects 1304 can include projects or instruments that were created by the user, that the user is an investor in, that the user is a payor for, that the user is a service provider for, and so on. In exemplary embodiments, the GUI 1300 can also identify a list 1306 of other users of the environment 100 that “follow” the user or a list 1308 of users that the user follows.

Exemplary embodiments of the present disclosure advantageously provide a platform through which stakeholders of any kind can find and support the payor role of a social impact bond via exemplary embodiments of the environment 100. Unlike conventional approaches to SIBs where governments, or in rare occurrence foundations, are the payor, exemplary embodiments of the present disclosure allows any number of stakeholders to pool their money together and participate in the payor role via the composite payor structure implemented by exemplary embodiments of the present disclosure. Stakeholders can be anyone or any organization and they can pledge any amount of money.

As one example, if a city wants to expand a small college as part of a downtown revitalization project. The economics of such expansion, which may be millions of dollars, may prevent the city from undertaking the expansion. In traditional economic development, after reviewing the economics, the city would likely not pursue the expansion. Utilizing the composite payor structure of exemplary embodiments of the present disclosure, the stakeholders may include the government (city, state, & county), local business (restaurants, hotels, stores), and citizens who want to see downtown revitalized. Assuming that the expansion will cost 18 million dollars, and the return on investment for the investor is 2 million dollars (e.g., a return on investment of approximately 11%), the total amount to be paid by the payors for the social impact bond is 20 million dollars. The city, state, and county can each contribute 5 million dollars for a combined contribution of 15 million dollars. The local businesses may combine to raise 4 million dollars (because they anticipate that the expansion will mean more people to buy their goods and/or service). Finally, the people of the city may combine to raise 1 million dollars. So, in total, the SIB has 20 million dollars in commitments from several different payors. An investor fronts the 18 million dollars and the project is started. The money is only transferred from the committed funds to the investor if the new expansion is successfully opened. This differs from traditional economic development and SIBs, because it allows all the stakeholders to pay for the successful completion of the project.

As another example, exemplary embodiments of the present disclosure can allow a user to create a SIB to reduce recidivism rates. The state, county, a local foundation, and the citizens can collectively commit 5 million dollars as payors to the SIB. For the state and the county it reduces their cost (enforcement, well-fair, prison costs etc.). For the foundation and the citizens it helps make the community safer. Again, traditional government financing may have prevented the government from pursuing this goal. By allowing the stakeholders collective contribute as payors to the SIB, the economics, in view of the social benefits, are manageable using the composite payor structure for the project.

Approaches implemented by exemplary embodiments of the present disclosure also differ from conventional approaches to implementing SIBs because exemplary embodiments of the environment 100 can provide an online, automated platform that allows the cost of the SIBs to be spread across may different users and over a specified time frame, so that projects associated with SIBs that would traditionally not be economical can be pursued without requiring a single user to bear the cost of paying for the SIB if the project associated with the SIB is successful.

Finding each payor has a fixed cost. When trying to raise several million dollars, one's time and capital would be much better spent going after commitments of hundreds of thousands of dollars compared to hundreds of dollars.

Additionally, social impact bonds may be used to support causes that governments cannot find the political will to support. The community could come together to be the payor and completely remove or eliminate government involvement from the bond or another financing process. For example, a community may decide to provide after school tutoring to students for free for 5 years with the goal of getting 20% more students into college. An SIB towards achieving this goal may require $1,000,000 from payors. When 10,000 community members come together to pledge on avg. $100 each via exemplary embodiments of the environment 100. Because the required capital is raised an investor(s) can be found and the SIB can move forward.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other embodiments, functions and advantages are also within the scope of exemplary embodiment of the present disclosure.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

What is claimed is:

1. A method of creating a graphical user interface for implementing a multi-payor investment environment in a project, the method comprising:
executing code, at a server, to generate a computing environment for multi-payor investment instruments or projects, the computing environment being accessible by a plurality of users via a communications network and providing at least one pre-configured graphical user interface for receiving and displaying information to the plurality of users;
receiving a request from a user to create a new graphical user interface for a multi-payor investment instrument or project via the at least one pre-configured graphical user interface;
executing code, at server, to generate the new graphical user interface in response to the request, the new graphical user interface including information associated with the multi-payor investment instrument or project received in the request;
wherein the new graphical user interface is accessible by other users via the computing environment to allow the other users to view contributors to the multi-payor investment instrument.

2. The method of claim 1, wherein the selected investment instrument or project is for the social good or is a social project.

3. The method of claim 1, wherein the computing environment is an online portal programmed to launch a pay for success project.

4. The method of claim 1, further comprising receiving a search request from the user or one of the other users to find at least one of an investor, payor, or service provider for the investment instrument or project.

5. The method of claim 1, further comprising:
executing code to manage payor contributions from the other users with respect to the investment instrument or project, wherein the payor contributions are payable to an investor for the instrument in response to achieving a desired goal.

6. The method of claim 5, further comprising executing code to automatically call money from the payor contributions on periodically to payback an investor in the investment instrument or project.

7. The method of claim 5, further comprising executing code to automatically return money to at least one of the other users that contributes as a payor via the computing environment if the desired goal is not achieved.

8. The method of claim 5, wherein the payor contributions are automatically distributed to investors upon successful completion of milestones associated with the selected investment instrument or project.

9. The method of claim 5, wherein the payor contributions, minus fees, is automatically distributed to investors upon achieving the desired goal.

10. A non-transitory computer-readable storage medium storing instructions, wherein execution of the instructions by the processing device causes the processing device to perform a method of creating a graphical user interface for implementing a multi-payor investment environment in a project comprising:
executing code, at a server, to generate a computing environment for multi-payor investment instruments or projects, the computing environment being accessible by a plurality of users via a communications network and providing at least one pre-configured graphical user interface for receiving and displaying information to the plurality of users;
receiving a request from a user to create a new graphical user interface for a multi-payor investment instrument or project via the at least one pre-configured graphical user interface;
executing code, at server, to generate the new graphical user interface in response to the request, the new graphical user interface including information associated with the multi-payor investment instrument or project received in the request;
wherein the new graphical user interface is accessible by other users via the computing environment to allow the other users to view contributors to the multi-payor investment instrument.

11. The medium of claim 10, wherein execution of the instructions causes the processing device to receive a search request from the user or one of the other users to find at least one of an investor, payor, or service provider for the investment instrument or project.

12. The method of claim 10, wherein execution of the instructions causes the processing device to execute code to manage payor contributions from the other users with respect to the investment instrument or project, wherein the payor contributions are payable to an investor for the instrument in response to achieving a desired goal.

13. The method of claim 10, further comprising executing code to automatically call money from the payor contributions on periodically to payback an investor in the investment instrument or project.

14. The method of claim 10, further comprising executing code to automatically return money to at least one of the other users that contributes as a payor via the computing environment if the desired goal is not achieved.

15. The method of claim 10, wherein the payor contributions are automatically distributed to investors upon successful completion of milestones associated with the selected investment instrument or project.

16. The method of claim 10, wherein the payor contributions, minus fees, is automatically distributed to investors upon achieving the desired goal.

17. A system for creating a graphical user interface for implementing a multi-payor investment environment in a project comprising:
a non-transitory computer-readable medium storing instructions for execution of a social impacting investing environment; and
a processing device in communication with the non-transitory computer-readable medium, the processing device being programmed to execute the instructions to:
generate a computing environment for multi-payor investment instruments or projects, the computing environment being accessible by a plurality of users via a communications network and providing at least one pre-configured graphical user interface for receiving and displaying information to the plurality of users;
receive a request from a user to create a new graphical user interface for a multi-payor investment instrument or project via the at least one pre-configured graphical user interface;
generate the new graphical user interface in response to the request, the new graphical user interface including information associated with the multi-payor investment instrument or project received in the request;
wherein the new graphical user interface is accessible by other users via the computing environment to allow the other users to view contributors to the multi-payor investment instrument.

18. The system of claim 17, wherein the processing device is programmed to receive a search request from the user or one of the other users to find at least one of an investor, payor, or service provider for the investment instrument or project.

19. The system of claim 17, wherein the processing device is programmed to execute code to manage payor contributions from the other users with respect to the investment instrument or project, wherein the payor contributions are payable to an investor for the instrument in response to achieving a desired goal.

20. The method of claim 17, wherein the processing device is programmed to automatically distributed the payor contributions to investors upon successful completion of milestones associated with the selected investment instrument or project.
